(19) United States
(12) Patent Application Publication
(10) Pub. No.: US 2024/0383346 A1
(43) Pub. Date: Nov. 21, 2024

(54) SEVEN-SWITCH INDIRECT MATRIX CONVERTER

(71) Applicants: BorgWarner Inc., Auburn Hills, MI (US); BOARD OF TRUSTEES OF MICHIGAN STATE UNIVERSITY, East Lansing, MI (US)

(72) Inventors: Woongkul Lee, Okemos, MI (US); Mikayla J. Benson, East Lansing, MI (US); Brian C. Wightman, Davisburg, MI (US); Luca Di Carlo, Teramo (IT)

(21) Appl. No.: 18/197,539

(22) Filed: May 15, 2023

(51) Int. Cl. B60L 53/10; B60L 53/22

(52) U.S. Cl. CPC B60L 53/11; B60L 53/22

(57) ABSTRACT

A direct current (DC) fast charger for charging batteries of electric vehicles (EVs), includes a primary circuit, including seven bidirectional switches, electrically linked to a primary wire of a transformer and configured to receive alternating current (AC) power from a power grid; a secondary circuit electrically linked to a secondary wire of the transformer for converting AC power into DC power; and a control system, electrically linked to the primary circuit and the secondary circuit, that changes the frequency of the AC power received from the power grid in five switching states.

### GOVERNMENT INTEREST

This invention was made with government support under the DE-EE0009869 contract, awarded by the United States Department of Energy, Energy Efficiency & Renewable Energy EE-1 Office. The U.S. Government has certain rights in the invention.

### TECHNICAL FIELD

The present application relates to electric vehicles (EVs) and, more particularly, to DC fast chargers charging EVs.

### BACKGROUND

Modern vehicles are increasingly propelled at least partially or wholly by electric motors. The vehicles, often referred to as electric vehicles (EVs), include a vehicle battery and one or more electric motors that drive the vehicle wheels. Some challenges exist as part of encouraging motorists to forsake their vehicles powered by internal combustion engines and embrace EVs. For example, motorists may refill a fuel tank for a vehicle powered by an internal combustion engine relatively quickly. However, recharging a vehicle battery included with an EV may take longer. As motorists purchase increasing quantities of EVs, they will want to be able to charge the vehicle batteries relatively quickly. Therefore, faster and more efficient vehicle battery chargers are helpful.

### SUMMARY

In one implementation, a direct current (DC) fast charger for charging batteries of electric vehicles (EVs) includes a primary circuit, having seven bidirectional switches, electrically linked to a primary wire of a transformer (with or without an external inductor) and configured to receive alternating current (AC) power from a power grid; a secondary circuit electrically linked to a secondary wire of the transformer for converting AC power into DC power; and a control system, electrically linked to the primary circuit and the secondary circuit, that changes the frequency of the AC power received from the power grid via state changes.

### BRIEF DESCRIPTION OF THE DRAWINGS

FIG. 1 is a block diagram depicting an implementation of an electric vehicle;

FIG. 2 is a circuit diagram depicting an implementation of a DC fast charger and a control system;

FIG. 3 is a flow chart depicting a method of

FIGS. 4a-4f are circuit diagrams depicting an implementation of a DC fast charger.

### DETAILED DESCRIPTION

An electric vehicle (EV) charging station is capable of receiving electrical power from a grid, inverting the received electrical power into form that quickly charges a vehicle battery, and supplying the power to an EV battery. The EV charging station described herein can be referred to as a “DC fast charger” such that it is a stationary EV battery charger coupled to an electrical grid and a vehicle battery through an EV charging plug. The DC fast charger can receive AC electrical power from the grid, invert the AC electrical power into DC electrical power, and supply the DC electrical power through the EV charging plug to the EV battery. The DC fast charger includes a seven-bidirectional-switch topology that permits bidirectional flow of electrical current from the charger to the EV (G2V) and from the EV to the charger (V2G).

The seven-switch topology implements an indirect matrix converter that uses specifically designed commutation methods to transform input low-frequency AC electrical power to high-frequency AC power via a control method. The DC fast charger also includes a high-frequency transformer and a full bridge rectifier/inverter. An inductor can be separately included or integrated with the transformer and a capacitance filter may be used at the output.

In contrast, previous six-switch topologies have used eight hard switching events to transform input AC electrical power into output DC electrical power. Hard switching events involve a switch under electrical load and can be less efficient than zero current switching events at the switch, which would not take place under an electrical load. That is, the seven-switch topology disclosed here and the control system used with it can decrease power loss with less complexity than previous vehicle chargers. Also, the seven-switch topology disclosed here can permit bidirectional flow of electrical current while controlling the AC power factor from leading, to unity, to lagging. The conduction loss during the zero switching and freewheeling state is also reduced by half in the seven-switch topology compared with the conventional six-switch topology.

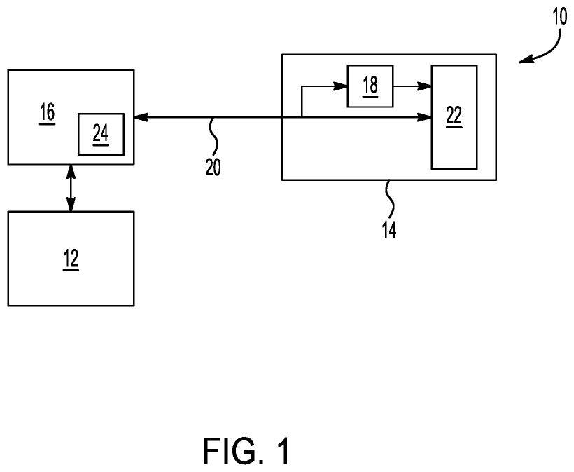

Turning to FIG. 1, an implementation of an electrical system 10 is shown including an electrical grid 12 and an electric vehicle (EV) 14 that can either receive electrical power from or provide electrical power to the grid 12. The electrical grid 12 can include any one of a number of electrical power generators and electrical delivery mechanisms. Electrical generators (not shown) create AC electrical power that can then be transmitted a significant distance away from the electrical generator for residential and commercial use. The electrical generator can couple with the electrical grid 12 that transmits the AC electrical power from the electrical generator to an end user, such as a residence or business. As the AC electrical power is provided to the electrical grid 12, the electrical power can exist at a relatively high voltage so that it can be communicated relatively long distances. Once the electrical power reaches a location where it is intended to be used, electrical transformers (not shown) can be used to reduce the voltage level before ultimately being provided to a residence or business. In one implementation, the voltage level of AC electrical power used is 360-510 volts RMS alternating current three-phase, 50-60 hz. However, this voltage range can be different.

An EV charging station, referred to here as a DC fast charger 16, can receive AC electrical power from the grid 12, rectify the AC electrical voltage into DC electrical power, and provide the DC electrical power to the EV 14. Also, the DC fast charger 16 can receive stored electrical power in the form of DC electrical voltage from an EV battery 22, invert the received DC electrical power to AC electrical power and transfer it to the grid 12. The DC fast charger 16 can be geographically fixed, such as a charging station located in a vehicle garage or in a vehicle parking lot. The DC fast charger 16 can include an input terminal that receives the AC electrical power from the grid 12 and communicates the AC electrical power to the EV battery 22 directly, bypassing an on-board vehicle battery charger 18 included on the EV 14. An electrical cable 20 can detachably connect with an electrical receptacle on the EV 14 and electrically link the DC fast charger 16 with the EV 14 so that DC electrical power can be communicated between the DC fast charger 16 and the EV battery 22. One type of DC fast charging may be referred to as Level 3 EV charging, considered to be 60-350 kW. However, other charging standards and power levels are possible with the structure and functionality disclosed here. The term “electric vehicle” or “EV” can refer to vehicles that are propelled, either wholly or partially, by electric motors. EV can refer to electric vehicles, plug-in electric vehicles, hybrid-electric vehicles, and battery-powered vehicles. The EV battery 22 can supply DC electrical power controlled by power electronics to the electric motors that propel the EV. The EV battery 22 or batteries are rechargeable. Examples of the battery include lead-acid batteries, nickel cadmium (NiCd), nickel metal hydride, lithium-ion, and lithium polymer batteries. However, battery technology is evolving and other chemistries and/or voltages may be used. A typical range of vehicle battery voltages can range from 100 to 1000V of DC electrical power (VDC).

A control system, implemented as computer-readable instructions executable by the microprocessor, can be stored in non-volatile memory and called on to control functionality of the DC fast charger 16. This will be discussed in more detail below.

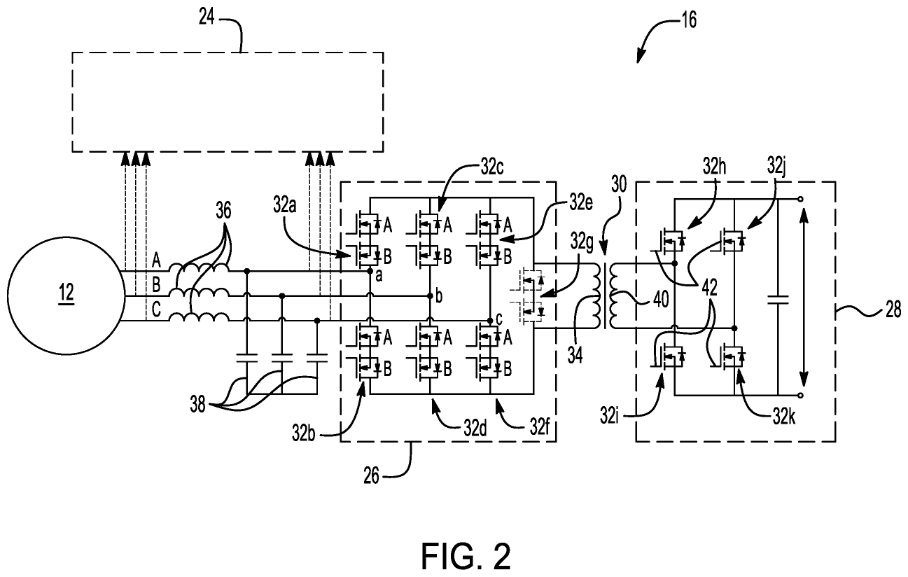

FIG. 2 depicts an implementation of the DC fast charger 16 and a control system 24 used with the charger 16. The DC fast charger 16 is an indirect matrix converter that includes a primary circuit 26 and a secondary circuit 28 inductively coupled together via a transformer 30. The primary circuit 26 includes seven switches 32 electrically coupled to the grid 12 and a primary winding 34 of the transformer 30. The switches 32 can be implemented using bipolar junction transistor or field effect transistors (FETs), such as insulated gate bipolar transistor (IGBT) and metal-oxide-semiconductor field effect transistors (MOSFETs). Another solution can be to use gallium nitride transistor (GaN). The switches 32 can be bidirectional or reverse-blocking such that they are four-quadrant switches capable of conducting positive or negative on-state current and blocking positive or negative off-state voltage. A number of different circuit configurations can be used to implement such a switch any of which could be implemented in the DC fast charger described herein. In one implementation, each switch 32 includes an A side MOSFET and a B side MOSFET with gates that can be electrically connected to a microprocessor. Six switches 32a-f can be electrically coupled to three legs of the electrical grid A, B, C and nodes a, b, c of the primary circuit 26. A seventh switch 32g can be wired in parallel with switches 32e and 32f, and with the primary winding 34 of the transformer 32. Inductors 36 and bulk capacitance 38 can be electrically connected to the three phases PHA, PHB, PHC of the grid 12 to add filtering or represent the phase inductances and capacitances of the grid.

The secondary circuit 28 is electrically connected to a secondary winding 40 of the transformer 30. The circuit 28 includes a full-bridge rectifier/inverter that can be implemented using four switches 32h-k. The switches 32 in the secondary circuit 28 can be implemented using non-bidirectional MOSFETs. The EV battery 22 can be electrically connected to the four switches 32h-k such that the secondary circuit 28 can be controlled to rectify AC power induced through the secondary winding 40 into DC power applied to the EV battery 22 for grid to vehicle functionality. Conversely, the EV battery 22 can be electrically connected to the four switches 32h-k such that the secondary circuit 28 can be controlled to invert the DC power to AC power induced to the secondary winding 40 for AC power to the power grid for vehicle to grid functionality.

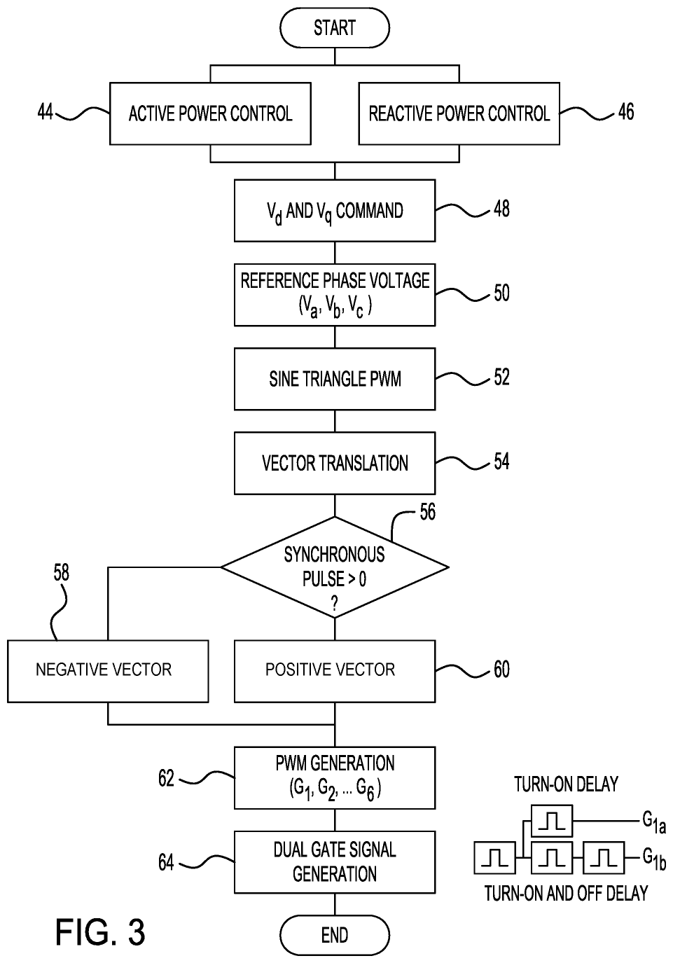

The control system 24 can be implemented using a microprocessor having outputs electrically connected to the gates 42 of the switches 32 in the DC fast charger 16. The DC fast charger can receive fourteen gate signals for fourteen main switches (twelve main switches and two additional switches for auxiliary function-low loss commutation) in the primary stage. The gate signal generation in the conventional indirect matrix converter relies on space vector modulation, which requires specific time duration calculation of each voltage or current vector. An implementation of the control system 24 is shown in a block diagram in FIG. 3. The control system 24 includes a phase locked loop electrically connected to the three legs PHA, PHB, PHC of the grid 12. The phase locked loop can be used to determine the phase (θ_{grid}) of the AC power received from the grid 12. The control system 24 can determine whether to actively control power 44 or reactively control power 46. A Vd and Vq command can be generated 48. The control system 24 can then determine a reference phase voltage (Vₐ, V_{b}, V_{c}). A sine triangle pulse width modulation (PWM) can be generated at block 52. A VSI-CSI conversion can occur at block 54. The control system 24 can then determine whether or not a synchronous pulse is greater than zero at block 56. Depending on this determination, a negative vector can be generated at block 58 or a positive vector can be generated at block 60. PWM generation can then occur at block 62 followed by dual gate signal generation at block 64, The proposed gate signal generation method uses simple sine triangle pulse width modulation, which is often used in a voltage-source inverter. The generated six gate signals can be generated from a vector translated (converted equivalent current vector and the current vector) polarity is changed based on the synchronous pulse alternating at the switching frequency. This is fed from Vd and Vq command controllers (active and reactive power). The six gate signals can be fed to a dual gate signal generation block where deadtime between two gate signals may be defined. The dual gate signal generation block contains one turn-on delay block for the top switch and both turn-on and off blocks for the bottom switch gate signal generation to avoid potential short-circuit paths, which helps control the bidirectional switch.

The DC fast charger 16 can control the primary circuit 26 to induce the flow of AC current in the transformer 30. The primary circuit 26 can lose power in the form of heat through switching losses. Reducing the energy lost in the primary circuit 26 can result in a more efficient DC fast charger, and reducing the heat produced helps reduce the overall size of the charger by reducing the size of the means of cooling the primary circuit and/or the size of the cooling equipment such as fans, refrigeration circuits, heat sinks and the like. Switching losses may be reduced by zero current switching the switches 32, which means they are switched in the absence of electrical current.

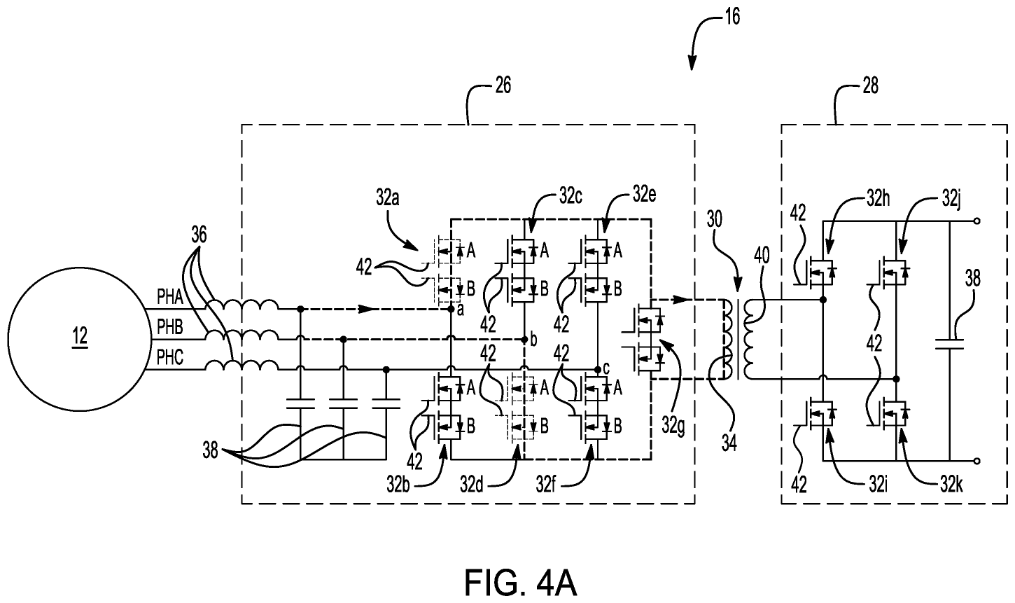

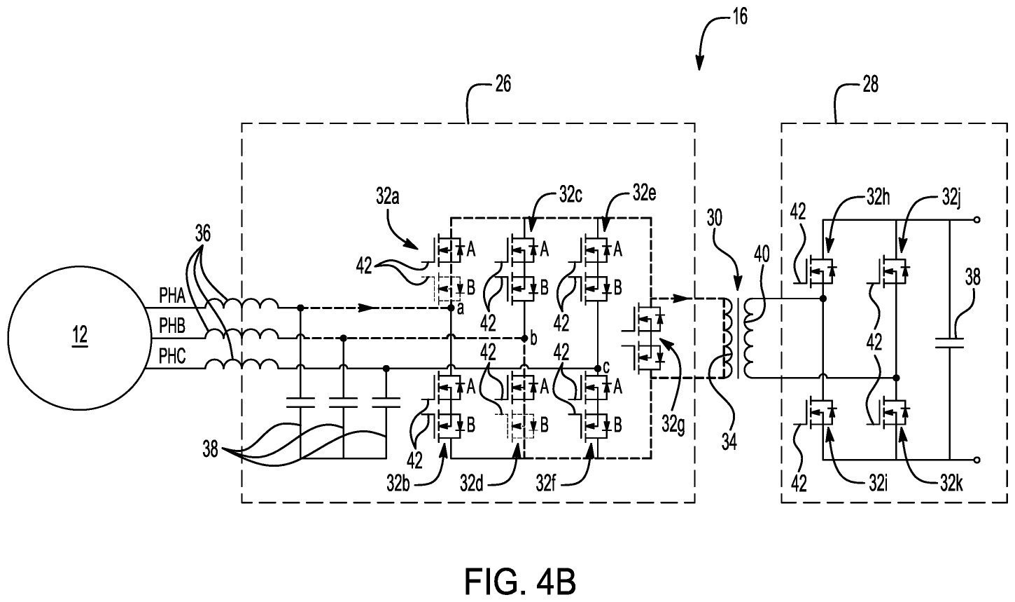

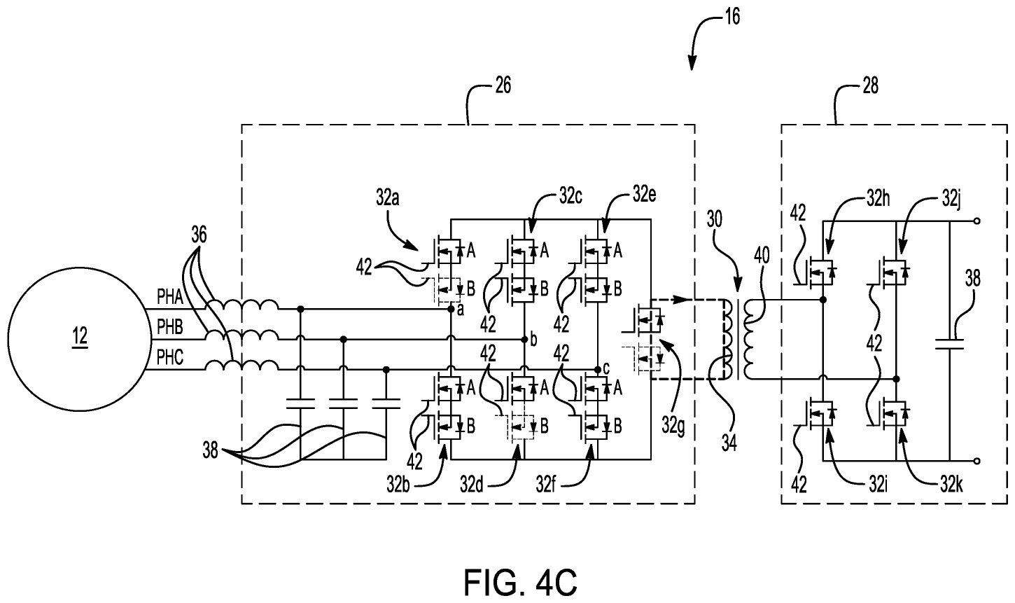

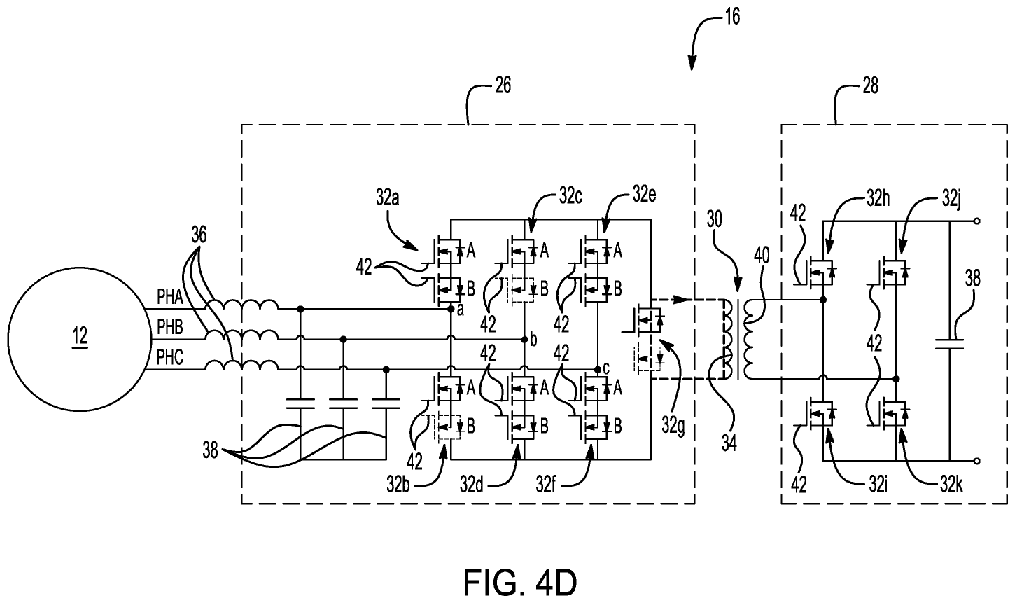

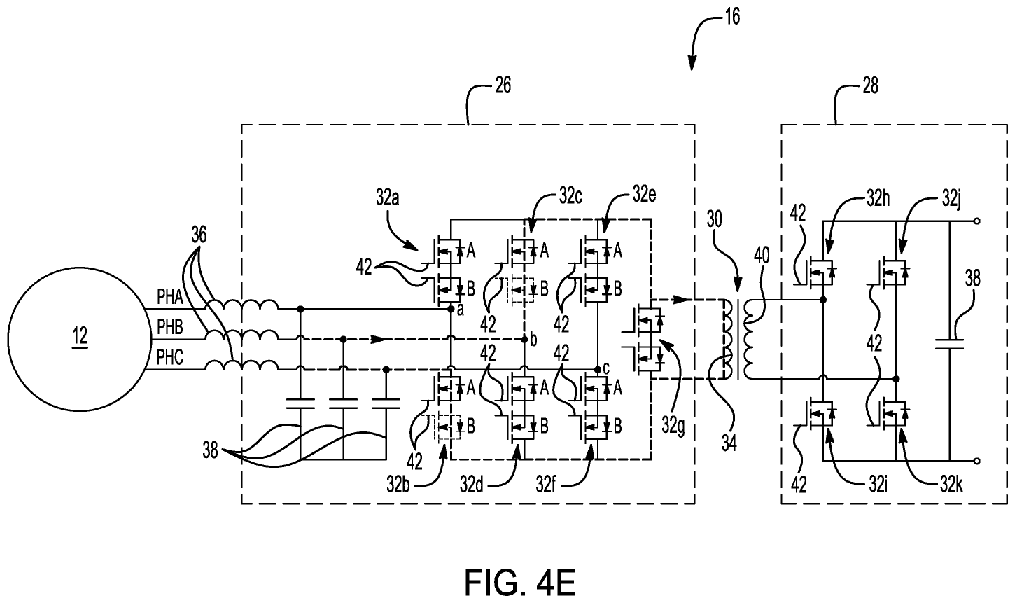

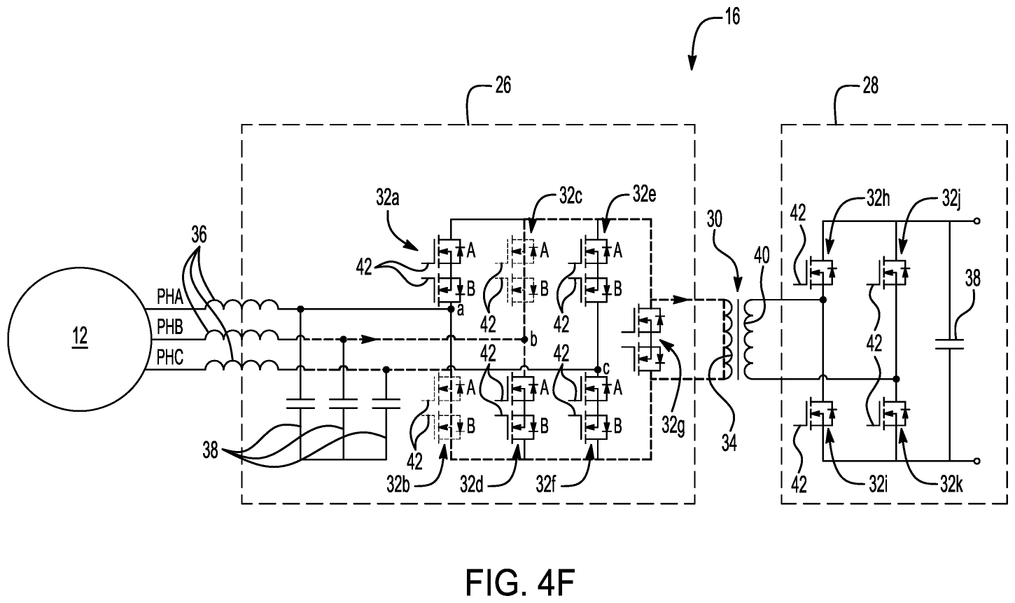

The change in the conductivity of the switches 32 included in the primary circuit 26 is shown in FIGS. 4a-f. An initial switch state of the primary circuit 26 is shown in FIG. 4a where the A and B MOSFETs of switches 32a and 32d are initially conductive to flow current through legs PHA and PHB. The choice of switches 32a and 32d conducting current through legs PHA and PHB is made to explain the control. Any pair of legs with the corresponding switches conductive to flow current is considered a return to the initial state. The current path and switch conductivity is shown with arrows and/or hashed lines. A first switching step can render the A side MOSFETs of switches 32a and 32d non-conductive as shown in FIG. 4b. A second switching step can render the B side MOSFET of the seventh switch 32g conductive as shown in FIG. 4c. A third switching step is shown in FIG. 4d, such that the B side MOSFET of switches 32a and 32d are rendered non-conductive, and the B side MOSFET of switches 32b and 32c are rendered conductive. The conductive state change of switches 32a, 32b, 32c, and 32d can be considered zero current switching events as they are made absent the presence of electrical current. FIG. 4e depicts a fourth switching state in which the B side MOSFET of switch 32g is rendered non-conductive. A fifth switching state is shown in FIG. 4f in which the A side MOSFET of switch 32c is rendered conductive and the A side of switch 32b is rendered conductive. The control system 24 has then returned the conductive state of the primary circuit 26 to the initial switch state for legs PHB and PHC and may repeat the switching states to change the frequency of the AC voltage received from the grid 12. In an exemplary embodiment, there are five switching states.

The DC fast charger has a capability to control both active and reactive power as well as bidirectional power flow in voltage control mode, which later may be translated to current source inverter (CSI) and indirect matrix converter. The conventional power factor correction and active/reactive power control theory can be easily implemented in the front-end of the controller as the equivalent PWM switching signals are generated through the translational method disclosed here.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A direct current (DC) fast charger for charging batteries of electric vehicles (EVs), comprising:
a primary circuit, including seven bidirectional switches, electrically linked to a primary wire of a transformer and configured to receive alternating current (AC) power from a power grid;
a secondary circuit electrically linked to a secondary wire of the transformer for converting AC power into DC power; and
a control system, electrically linked to the primary circuit and the secondary circuit, that changes the frequency of the AC power received from the power grid in five switch state changes.

2. The DC fast charger recited in claim 1, wherein the switch states are determined using dual gate pulse width modulation from a synchronous negative or positive vector and a modulated sine triangle pulse width modulation signal processed from AC phase voltages compared to requested active and reactive power.

3. The DC fast charger recited in claim 1, wherein bidirectional switches include an A side MOSFET and a B side MOSFET.

4. The DC fast charger recited in claim 1, wherein at least one switch conductivity change is made absent the presence of electrical current.

5. The DC fast charger recited in claim 1, wherein three switch conductivity changes are made absent the presence of electrical current.

6. The DC fast charger recited in claim 1, wherein two switch conductivity changes are made in the presence of electrical current.

7. The DC fast charger recited in claim 1, wherein the primary circuit receives AC power from and provides AC power to the power grid via bidirectional power flow.

8. The DC fast charger recited in claim 1, wherein the primary circuit changes a power factor to be leading, unit, and lagging.

9. The DC fast charger recited in claim 1, wherein the primary circuit uses the primary wire of the transformer as a leakage inductor.
